(19) United States
(12) Patent Application Publication
(10) Pub. No.: US 2022/0094063 A1
(43) Pub. Date: Mar. 24, 2022

(54) WEARABLE TERMINAL

(71) Applicants: Haruo HAYAKAWA, Kanagawa (JP); Yuki TANAKA, Tokyo (JP); Ryosuke HASABA, Kanagawa (JP); Kazuki KANAI, Kanagawa (JP); Yoshio KOYANAGI, Kanagawa (JP)

(72) Inventors: Haruo HAYAKAWA, Kanagawa (JP); Yuki TANAKA, Tokyo (JP); Ryosuke HASABA, Kanagawa (JP); Kazuki KANAI, Kanagawa (JP); Yoshio KOYANAGI, Kanagawa (JP)

(21) Appl. No.: 17/541,632

(22) Filed: Dec. 3, 2021

Related U.S. Application Data
(63) Continuation of application No. PCT/JP2020/022301, filed on Jun. 5, 2020.

(30) Foreign Application Priority Data
Jun. 7, 2019 (JP) 2019-107139

(51) Int. Cl. H01Q 9/04; H01Q 1/48; H01Q 1/22

(52) U.S. Cl. CPC H01Q 9/0421; H01Q 1/2225; H01Q 1/48

(57) ABSTRACT

A wearable terminal includes a support body, an antenna having a first metal layer and a second metal layer, a board, and a covering film. The first metal layer constitutes an antenna element and the second metal layer constitutes a ground. The first metal layer and the second metal layer each are made of a metal having flexibility or a metal foil formed on a material having flexibility. The first metal layer is bonded to the covering film. The support body or the antenna includes a cushion member. The cushion member is sandwiched between the first metal layer and the second metal layer. The covering film is bonded to the support body. A composite of the second metal layer and the board is not bonded to the cushion member.

### CROSS-REFERENCE TO RELATED APPLICATIONS

This is a continuation of International Application No. PCT/JP2020/022301 filed on Jun. 5, 2020, and claims priority from Japanese Patent Application No. 2019-107139 filed on Jun. 7, 2019, the entire content of which is incorporated herein by reference.

### TECHNICAL FIELD

The present disclosure relates to a wearable terminal.

### BACKGROUND ART

JP-A-2007-286214 discloses a wearing band provided with an inlet for wirelessly transmitting information recorded in an IC chip by an antenna. The wearing band is formed in a ring shape wearable to a part of a human body. The wearing band includes an RFID tag containing the inlet by a hard film made of a resin, and an elastic body including the RFID tag and formed in a ring shape. The RFID tag is configured such that a strain in a tensile direction per unit tensile force is smaller than that of the elastic body.

The technique described above relates to the wearing band suitable for identifying an individual by being worn on a part of a human body. However, since the hard film contains the inlet, rigidity of the hard film makes the RFID tag less bendable. Further, the above technique is different in structure from a wearable terminal of the present disclosure, which can also use energy harvesting, on the premise of a two-layer structure of an antenna element and a ground (GND).

There is a demand for a wearable terminal that can be worn on a human body. As a specific example, a wristband wrapped around a wrist of a patient in a hospital or the like corresponds to this demand. However, the wearable terminal is not limited to the wristband, and may be a belt or the like wrapped around a waist of a human.

In the related art, wristbands using a two-dimensional bar code have been used for the management of inpatients in hospitals. A printing surface is formed on a soft material such as silicone using a material such as PET, and a barcode is printed on the printing surface. By reading this barcode, it is possible to manage data of the inpatient who has a wristband wrapped around an arm thereof (wrist).

However, the above-described wristband is inconvenient in that it is vulnerable to contamination and requires a nurse or the like to hold a barcode reader to read the barcode.

Therefore, instead of the wristband having the above configuration, a wristband incorporating RFID has come to be used. Since RFID is capable of performing wireless communication from the outside, RFID can communicate without problems even if the surface of the wristband becomes dirty, and it is not necessary to bring a barcode reading device close to RFID.

FIG. 23 is a top view illustrating an example of a related-art wristband using RFID. FIG. 24 is a side view illustrating the example of the related-art wristband using RFID. FIG. 25 is a diagram illustrating a state in which the example of the related-art wristband using RFID is wrapped around an arm. A wristband 5 illustrated in FIGS. 23 to 25 is formed by disposing an RFID antenna 52 on a cushion member 51 having flexibility such as silicone rubber. When the wristband having the above configuration is wrapped around the arm as illustrated in FIG. 25, the RFID antenna 52 is curved so as to follow an arc of the arm. However, although in the above configuration, the wristband itself can be wrapped around the arm, there is a problem that an antenna performance is deteriorated because radio waves from the outside are absorbed by moisture contained in a human body such as the arm.

Therefore, in order to improve the antenna performance, a terminal in which a metal body is disposed as a ground on an inner surface thereof can be considered. FIG. 26 is a top view illustrating a configuration of a terminal 6 including a ground. FIG. 27 is a side view illustrating the configuration of the terminal 6 including the ground. FIG. 28 is a diagram illustrating a state in which the terminal 6 including the ground is wrapped around the arm.

As illustrated in FIGS. 26 to 28, an antenna element 62 is fixed to an outer surface (a surface opposite to a side in contact with the arm) of a cushion member 61 included in the terminal 6, and a metal ground 63 is fixed to an inner surface (a surface at a side in contact with the arm) of the cushion member 61. In the above configuration, the ground 63 prevents radio waves from the outside from escaping to the human body such as the arm. Therefore, the antenna performance is improved by the above configuration.

However, in the above-described structure having two layers of the antenna element 62 and the ground 63, it is necessary to ensure a predetermined distance between the antenna element 62 and the ground 63. Further, the antenna element 62 needs to have a sufficient size in comparison with a wavelength. Then, when the terminal 6 is to be made wearable, the following new problem occurs.

When the terminal 6 having the above configuration is wrapped around the arm, as illustrated in FIG. 28, the arc formed by the ground 63 has a smaller radius of curvature than the arc formed by the antenna element 62. Therefore, an extra length portion is generated at each of end portions of the ground 63 due to the curvature, and the end portions of the ground 63 are stretched, so that the terminal 6 cannot be curved with a large curvature (a small curvature radius). If the antenna element 62 is forcibly bent, the antenna element 62 or the like is broken. Further, at a broken position, the predetermined distance between the antenna element 62 and the ground 63 cannot be maintained, and characteristics of the antenna cannot be maintained.

As described above, it is difficult to make the terminal having the two layers of the antenna element and the ground wearable so as not to cause the above-described problem when the terminal is curved with the large curvature (the small curvature radius) such as wrapping around the arm.

### SUMMARY OF INVENTION

The present disclosure has been made in view of the above problems, and an object thereof is to provide a terminal having two layers of an antenna element and a ground that has sufficient flexibility as a whole and is wearable.

A wearable terminal includes a support body, an antenna having a first metal layer and a second metal layer, a board, and a covering film that covers the first metal layer, the second metal layer, and the board, in which: the first metal layer constitutes an antenna element and the second metal layer constitutes a ground, the first metal layer and the second metal layer each are made of a metal having flexibility or a metal foil formed on a material having flexibility, the first metal layer is bonded to the covering film, the support body or the antenna includes a cushion member, the cushion member is attached so that the cushion member is sandwiched between the first metal layer and the second metal layer, and the cushion member separates the first metal layer and the second metal layer by a predetermined distance, the covering film is bonded to the support body, and a composite of the second metal layer and the board is not bonded to the cushion member.

According to the above configuration, the terminal having the two layers of the antenna element and the ground has sufficient flexibility as a whole and is wearable.

### BRIEF DESCRIPTION OF DRAWINGS

FIG. 1 is a side view illustrating an antenna 1A before being attached to a support body 2.

FIG. 2 is a side view illustrating a wearable terminal 101 including the antenna 1A according to a first embodiment of the present disclosure, and illustrating a state after the antenna 1A is attached to the support body 2.

FIG. 3 is a top view illustrating the wearable terminal 101 including the antenna 1A according to the first embodiment of the present disclosure, and illustrating the state after the antenna 1A is attached to the support body 2.

FIG. 4 is a diagram illustrating a state before the wearable terminal 101 is worn on a human body (an arm in the present example).

FIG. 5 is a diagram illustrating a state after the wearable terminal 101 is worn on the human body (the arm in the present example).

FIG. 6 is a top view illustrating a wearable terminal 102 including an antenna 1B according to a second embodiment of the present disclosure, and illustrating a state after the antenna 1B is attached to the support body 2.

FIG. 7 is a side view illustrating the wearable terminal 102 including the antenna 1B according to the second embodiment of the present disclosure, and illustrating the state after the antenna 1B is attached to the support body 2.

FIG. 8 is a diagram illustrating a state before the wearable terminal 102 is worn on the human body (the arm in the present example).

FIG. 9 is a diagram illustrating a state after the wearable terminal 102 is worn on the human body (the arm in the present example).

FIG. 10 is a diagram illustrating an antenna 1C.

FIG. 11 is a side view illustrating a wearable terminal 103 including the antenna 1C according to a third embodiment of the present disclosure, and illustrating a state after the antenna 1C is attached to the support body 2.

FIG. 12 is a top view illustrating the wearable terminal 103 including the antenna 1C according to the third embodiment of the present disclosure, and illustrating the state after the antenna 1C is attached to the support body 2.

FIG. 13 is a diagram illustrating attachment of the unit type antenna 1C illustrated in FIGS. 10 to 12 to a main body 21 of the support body 2.

FIG. 14 is a diagram illustrating a state before the wearable terminal 103 is worn on the human body (the arm in the present example).

FIG. 15 is a diagram illustrating a state after the wearable terminal 103 is worn on the human body (the arm in the present example).

FIG. 16 is a top view illustrating a structure of the wearable terminal 103.

FIG. 17 is a side view illustrating the structure of the wearable terminal 103.

FIG. 18 is a cross-sectional view taken along a line A-A of FIG. 16 and illustrating the structure of the wearable terminal 103.

FIG. 19 is a perspective view illustrating a state in which the wearable terminal 103 illustrated in FIGS. 16 to 18 is curved in a ring shape.

FIG. 20 is a front view illustrating the state in which the wearable terminal 103 illustrated in FIGS. 16 to 18 is curved in the ring shape.

FIG. 21 is a side view illustrating the state in which the wearable terminal 103 illustrated in FIGS. 16 to 18 is curved in the ring shape.

FIG. 22 is a cross-sectional view taken along a chain line portion of FIG. 19 and illustrating the state in which the wearable terminal 103 illustrated in FIGS. 16 to 18 is curved in the ring shape.

FIG. 23 is a top view illustrating an example of a related-art wristband using RFID.

FIG. 24 is a side view illustrating an example of the related-art wristband using RFID.

FIG. 25 is a diagram illustrating a state in which the example of the related-art wristband using RFID is wrapped around the arm.

FIG. 26 is a top view illustrating a configuration of a terminal 6 including a ground.

FIG. 27 is a side view illustrating the configuration of the terminal 6 including the ground.

FIG. 28 is a diagram illustrating a state in which the terminal 6 including the ground is wrapped around the arm.

### DESCRIPTION OF EMBODIMENTS

Hereinafter, the present disclosure will be described in detail with reference to the drawings as appropriate. Note that the accompanying drawings and the following description are provided for a person skilled in the art to sufficiently understand the present disclosure, and are not intended to limit the subject matter described in the claims.

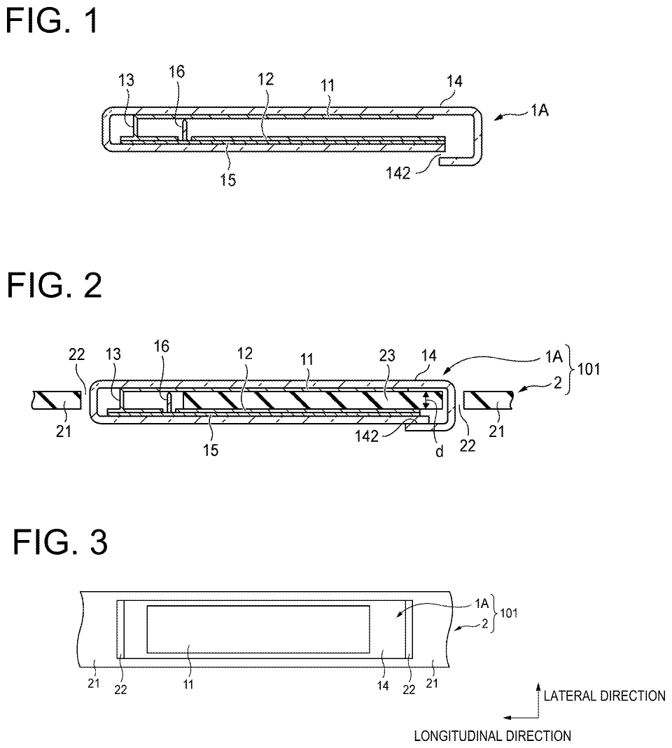

FIG. 1 is a side view illustrating an antenna 1A before being attached to a support body 2. FIG. 2 is a side view illustrating the wearable terminal 101 including the antenna 1A according to a first embodiment of the present disclosure, and illustrating a state after the antenna 1A is attached to the support body 2. FIG. 3 is a top view illustrating the wearable terminal 101 including the antenna 1A according to the first embodiment of the present disclosure, and illustrating the state after the antenna 1A is attached to the support body 2.

As illustrated in FIG. 1, the antenna 1A includes a first metal layer 11 constituting an antenna element and a second metal layer 12 constituting a ground. Each of the first metal layer 11 and the second metal layer 12 is made of a metal having flexibility or a metal foil formed on a material having flexibility. Noted that “flexible” and “having flexibility” in the present application mean that an expansion and contraction ratio thereof is ±3% or more. As an example, each of the first metal layer 11 and the second metal layer 12 may be formed of a copper plate.

The first metal layer 11 and the second metal layer 12 are disposed so as to face each other substantially parallel to each other, and a gap exists therebetween. A cushion member 23, which will be described later, is received in this gap. The first metal layer 11 and the second metal layer 12 are connected to each other via a short-circuit portion 13. Further, the first metal layer 11 and a board 15 to be described later are connected to each other via a power supply pin 16. Accordingly, the antenna 1A is also called an inverted F-shaped antenna since the antenna has a shape of an inverted F. The second metal layer 12 may have a larger area than the first metal layer 11. The board 15 is provided on a back surface of the second metal layer 12, and the board 15 and the second metal layer 12 are bonded to each other and are connected to the ground. Therefore, hereinafter, the board 15 and the second metal layer 12 may be treated as a composite. The board 15 may be, for example, a flexible printed circuit board (FPC).

The antenna 1A of the present disclosure further includes a covering film 14. The covering film 14 is a resin film such as PET, and a thin film having flexibility is used. The covering film 14 covers the first metal layer 11, the second metal layer 12, and the short-circuit portion 13.

The first metal layer 11 is bonded to the covering film 14. On the other hand, the composite configured with the board 15 and the second metal layer 12 is not bonded to the covering film 14. Therefore the composite is slidable with respect to the covering film 14.

A state in which the antenna 1A having the above-described configuration is attached to the support body 2 will be described with reference to FIGS. 2 and 3. A lateral direction in FIG. 3 is defined as a longitudinal direction of the support body 2, and a vertical direction in FIG. 3 is defined as a lateral direction of the support body 2.

A specific example of the support body 2 is a wristband. However, the support body 2 may be a belt or the like to be worn on the waist, and is used by being worn on the human body. In the following description, it is assumed that the support body 2 is a wristband.

The support body 2 includes a main body 21. Here, since the support body 2 is used by being worn on the human body, the main body 21 is made of a soft material such as silicone rubber such that the support body 2 can be curved with a curvature equal to or larger than a certain value (a curvature radius equal to or smaller than a certain value).

The support body 2 includes a cushion member 23 for attaching the antenna 1A. The cushion member 23 may be integrally formed with the main body 21, and a separately formed cushion member 23 may be fixed to the main body 21 by bonding or the like.

The cushion member 23 is a nonconductor having a predetermined thickness d, and is used such that the thickness does not change before and after curving even when the cushion member 23 is curved. The expression “the thickness does not change” here means that a variation of the thickness falls within a range of ±40% of the predetermined thickness d. The predetermined thickness d of the cushion member 23 is, for example, 3 mm to 5 mm.

The material of the cushion member 23 may be the same as or different from the material of the main body 21. As an example, the material of the cushion member 23 may be silicone rubber. However, the present disclosure is not limited thereto.

An upper surface of the support body 2 and the cushion member 23 in FIG. 2 is referred to as an outer surface, and a lower surface of the support body 2 and the cushion member 23 in FIG. 2 is referred to as an inner surface. When the support body 2 is a wristband, the inner surface of the support body 2 and the arm are in contact with each other.

Further, the support body 2 has a hole portion 22 disposed in the longitudinal direction of the support body 2. The hole portion 22 is provided between the main body 21 and the cushion member 23. The function of the hole portion 22 will be described later.

The attachment of the antenna 1A to the support body 2 as described above is performed, for example, as follows. As illustrated in FIGS. 1 and 2, the covering film 14 has an opening portion 142 at a predetermined position. In a state in which the opening portion 142 is opened (see FIG. 1), the antenna 1A is attached by being inserted into the cushion member 23. Then, by closing the opening portion 142 by bonding or the like, the antenna 1A is attached to the support body 2 so as not to easily fall off.

The covering film 14 may be bonded to a part of the support body 2. For example, the outer surface (the upper surface in FIG. 2) of the cushion member 23 and a surface facing the covering film 14 can be bonded to each other. Further, the covering film 14 and another position of the support body 2 may be bonded to each other. This bonding position depends on the shape of the support body 2.

By attaching the antenna 1A to the support body 2 as described above, the wearable terminal is brought into the following state.
The ground (second metal layer 12) is disposed at a position closer to the human body than the antenna element (first metal layer 11).
The covering film 14 is bonded to a part of the support body 2.
The antenna element (first metal layer 11) is bonded to the covering film 14.
The composite of the ground (second metal layer 12) and the board 15 is not bonded to the covering film 14.
The composite of the ground (second metal layer 12) and the board 15 is not bonded to the cushion member 23.
The antenna element (first metal layer 11) is connected to the ground (second metal layer 12) via the short-circuit portion 13. Therefore, the ground (second metal layer 12) does not fall off.

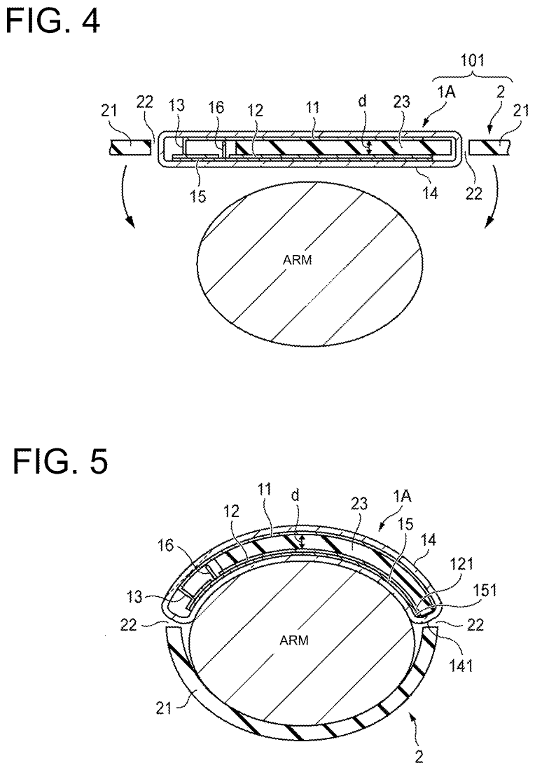

The wearable terminal 101 having the support body 2 to which the antenna 1A is attached as described above is worn on the human body. FIG. 4 is a diagram illustrating a state before the wearable terminal 101 is worn on the human body (the arm in the present example). FIG. 5 is a diagram illustrating a state after the wearable terminal 101 is worn on the human body (the arm in the present example). In this example, it is assumed that the belt-shaped support body 2 is wrapped around and worn on an arm, and an illustration of a fastener for fastening both ends of the belt-shaped support body 2 is omitted.

The support body 2 illustrated in FIG. 4 is not yet curved. By wrapping the support body 2 around the arm, the state illustrated in FIG. 5 is obtained, and the entire support body 2 including the cushion member 23 is curved.

Due to the curvature of the first metal layer 11 constituting the antenna element of the antenna 1A, the cushion member 23 is also curved following the curvature of the first metal layer 11. On the other hand, since the second metal layer 12 constituting the ground of the antenna 1A is not bonded to the cushion member 23, the second metal layer 12 is curved in accordance with the shape of the arm while sliding on a surface of the cushion member 23.

Since the cushion member 23 having the predetermined thickness d is disposed, a distance between the first metal layer 11 and the second metal layer 12 is kept constant before and after the above-described curvature.

After the curvature, an arc formed by the second metal layer 12 constituting the ground has a smaller radius of curvature than an arc formed by the first metal layer 11 constituting the antenna element. Therefore, an extra length portion 121 other than the arc length necessary for the small radius of curvature may be generated at an end portion of the second metal layer 12 along with the curvature. However, the hole portion 22 provided in the support body 2 accommodates the extra length portion. The hole portion 22 also accommodates an extra length portion 151 of the board 15 and an extra length portion 141 of the covering film 14.

As described above, even when the wearable terminal 101 having the support body 2 to which the antenna 1A is attached is worn on the human body and is curved, the first metal layer 11 and the second metal layer 12 is not broken. Further, the distance between the first metal layer 11 and the second metal layer 12 can be kept constant. Accordingly, the terminal 101 having the two layers of the antenna element and the ground has sufficient flexibility as a whole and is wearable.

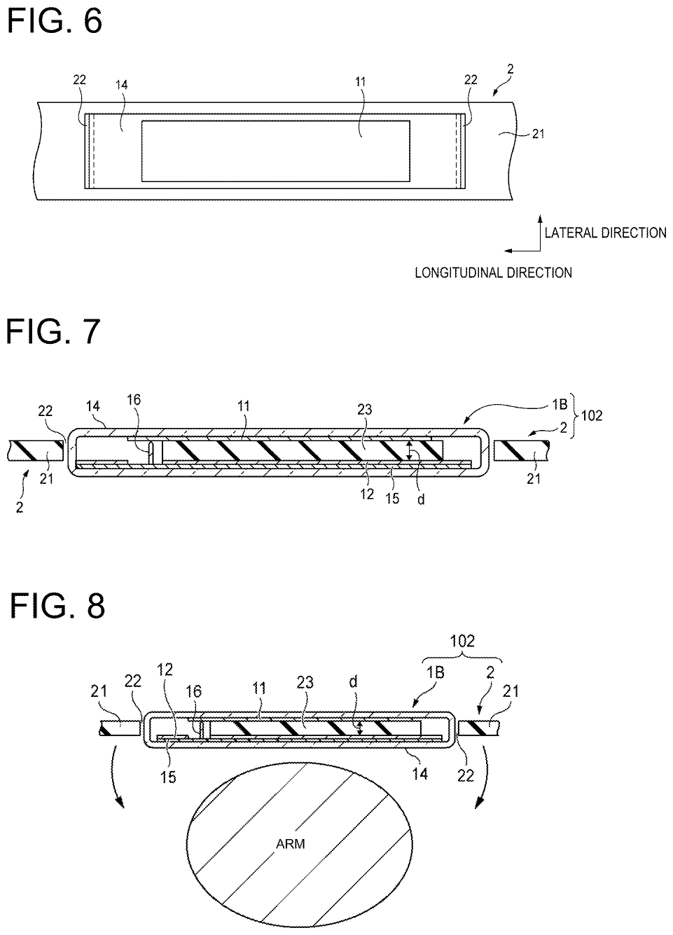

FIG. 6 is a top view illustrating a wearable terminal including an antenna according to a second embodiment of the present disclosure, and illustrating a state after the antenna is attached to the support body 2. FIG. 7 is a side view illustrating the wearable terminal 102 including the antenna 1B according to the second embodiment of the present disclosure, and illustrating the state after the antenna 1B is attached to the support body 2. A lateral direction in FIG. 6 is defined as a longitudinal direction of the support body 2, and a vertical direction in FIG. 6 is defined as a lateral direction of the support body 2.

In the second embodiment of the present disclosure illustrated in FIGS. 6 and 7, the antenna 1B has substantially the same configuration as the antenna 1A described based on FIGS. 1 to 5. Therefore, the same components are denoted by the same reference numerals, and a description thereof will be omitted.

The antenna 1A illustrated in FIGS. 1 to 5 uses the inverted F-shaped antenna. On the other hand, the antenna 1B illustrated in FIGS. 6 and 7 uses a patch antenna.

The antenna 1B is similar to the antenna 1A in that the antenna 1B includes the first metal layer 11 and the second metal layer 12, the first metal layer 11 constitutes an antenna element, and the second metal layer 12 constitutes a ground (GND). Similarly, the antenna 1B includes the board 15, and the board 15 and the second metal layer 12 are bonded to each other and are also connected to the ground. Therefore, hereinafter, the board 15 and the second metal layer 12 may be treated as a composite.

The board 15 may be, for example, a flexible printed circuit board (FPC). The first metal layer 11, which is the antenna element, is connected to the board 15 via the power supply pin 16. With the above configuration, electromagnetic waves such as microwaves received from the outside by the first metal layer 11 constituting the antenna element can be used for power supply. That is, the antenna 1B can be an RF energy harvest terminal.

In the examples of FIGS. 6 and 7, the second metal layer 12 is disposed on a side closer to the cushion member 23 than the board 15. However, a positional relationship between the second metal layer 12 and the board 15 may be reversed. That is, the board 15 may be disposed on the side closer to the cushion member 23. By determining the thickness of the cushion member 23 in consideration of the thickness of the board 15, the distance between the first metal layer 11 and the second metal layer 12 can be maintained at a predetermined distance.

Similarly to the antenna 1A, when the antenna 1B is attached to the support body 2, the following state is obtained.
The ground (second metal layer 12) is disposed at a position closer to a human body than the antenna element (first metal layer 11).
The covering film 14 is bonded to a part of the support body 2.
The antenna element (first metal layer 11) is bonded to the covering film 14.
The composite of the ground (second metal layer 12) and the board 15 is bonded to the covering film 14.
The composite of the ground (second metal layer 12) and the board 15 is not bonded to the cushion member 23.
The antenna element (first metal layer 11) is connected to the board 15 via the power supply pin 16.

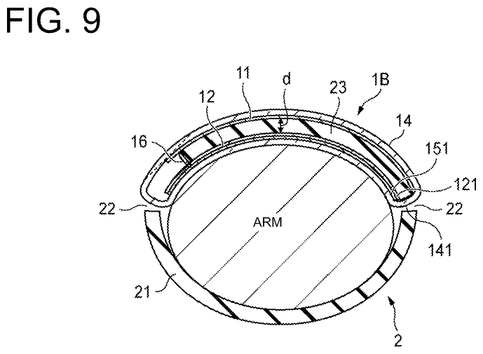

The wearable terminal 102 having the support body 2 to which the antenna 1B is attached as described above is worn on the human body. FIG. 8 is a diagram illustrating a state before the wearable terminal 102 is worn on the human body (an arm in the present example). FIG. 9 is a diagram illustrating a state after the wearable terminal 102 is worn on the human body (the arm in the present example). In this example, it is assumed that the belt-shaped support body 2 is wrapped around and worn on the arm, and an illustration of a fastener for fastening both ends of the belt-shaped support body 2 is omitted.

The support body 2 illustrated in FIG. 8 is not yet curved. By attaching the support body 2 to the arm, the state illustrated in FIG. 9 is obtained, and the entire support body 2 including the cushion member 23 is curved.

The first metal layer 11 constituting the antenna element of the antenna 1B curves following the curvature of the cushion member 23. On the other hand, since the composite of the board 15 and the second metal layer 12 constituting the ground of the antenna 1B is not bonded to the cushion member 23, the composite is curved in accordance with the shape of the arm while sliding on a surface of the cushion member 23.

Since the cushion member 23 having the predetermined thickness d is disposed, a distance between the first metal layer 11 and the second metal layer 12 is kept constant before and after the above-described curvature.

After the curvature, an arc formed by the second metal layer 12 constituting the ground has a smaller radius of curvature than an arc formed by the first metal layer 11 constituting the antenna element. Therefore, the extra length portion 121 may be generated at an end portion of the second metal layer 12 along with the curvature. Similarly, the extra length portion 151 may also be generated in the board 15. However, the hole portion 22 provided in the support body 2 accommodates the extra length portions. Further, the hole portion 22 also accommodates the extra length portion 141 of the covering film 14.

As described above, even when the wearable terminal 102 having the support body 2 to which the antenna 1B is attached is worn on the human body and is curved, the first metal layer 11 and the second metal layer 12 is not broken. Further, the distance between the first metal layer 11 and the second metal layer 12 can be kept constant. Accordingly, the terminal 102 having the two layers of the antenna element and the ground has sufficient flexibility as a whole and is wearable.

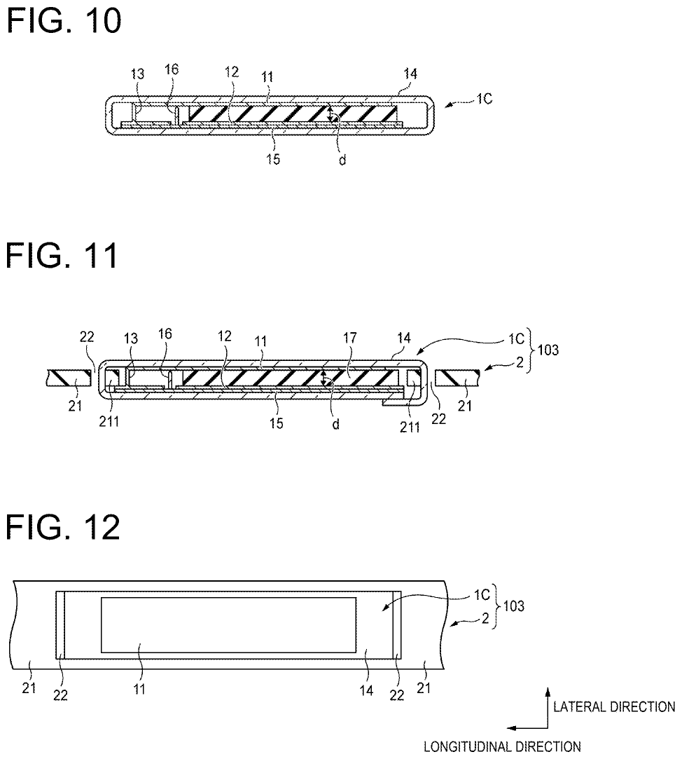

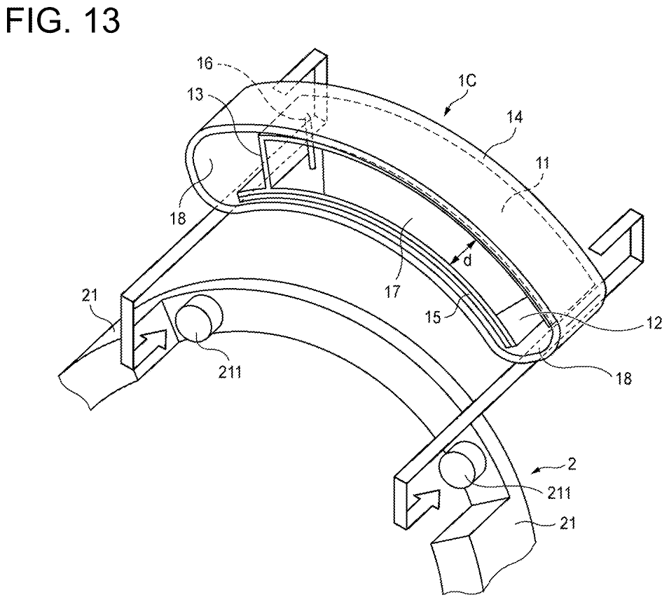

FIG. 10 is a diagram illustrating an antenna 1C. FIG. 11 is a side view illustrating a wearable terminal 103 including the antenna 1C according to a third embodiment of the present disclosure, and illustrating a state after the antenna 1C is attached to the support body 2. FIG. 12 is a top view illustrating the wearable terminal 103 including the antenna 1C according to the third embodiment of the present disclosure, and illustrating the state after the antenna 1C is attached to the support body 2. A lateral direction in FIG. 12 is defined as a longitudinal direction of the support body 2, and a vertical direction in FIG. 12 is defined as a lateral direction of the support body 2.

The antenna 1C illustrated in FIGS. 10 to 12 has substantially the same configuration as the antenna 1A described based on FIGS. 1 to 5. Therefore, the same components are denoted by the same reference numerals, and a description thereof will be omitted.

Similar to the antenna 1A described above, the antenna 1C uses an inverted F-shaped antenna. A main difference between the antenna 1A and the antenna 1C is that the antenna 1C is unitized and a cushion member 17 is provided not in the support body 2 but in the antenna 1C.

In the first embodiment (FIGS. 1 to 5) and the second embodiment (FIGS. 6 to 9) described above, the support body 2 includes the cushion member 23. However, when the cushion member 23 is integrally molded with the main body 21 of the support body 2, the cost may be increased.

For example, when the support body 2 is a wristband, the main body 21 of the support body 2 corresponds to a belt portion of a wristwatch. From the viewpoint of fashionability, it is conceivable that the material of the support body 2 is not silicone but a high-grade material (for example, leather). At this time, if the antenna 1C including the cushion member is configured to be detachable from the main body 21 of the support body 2, it is possible to mount the cushion member with a material different from that of the main body 21, which is preferable.

Therefore, a group in which the cushion member 17 is further added to the inverted F-shaped antenna (the first metal layer 11, the second metal layer 12, the short-circuit portion 13, and the power supply pin 16) and the covering film 14 is set as a unit of the antenna 1C (see FIGS. 10 and 11). The unit of the antenna 1C is attached to the main body 21 (see FIGS. 11 and 12).

That is, in the third embodiment, the cushion member 17 provided in the antenna 1C is a separate body from the main body 21 of the support body 2. The material of the cushion member 17 and the predetermined thickness d are similar to those of the cushion member 23 described in the first embodiment.

Further, the hole portion 22 provided in the support body 2 is provided between the main body 21 and the cushion member 17 when the unit of the antenna 1C is attached to the main body 21 of the support body 2. The function of the hole portion 22 is similar to that of the first embodiment.

FIG. 13 is a diagram illustrating attachment of the unit type antenna 1C illustrated in FIGS. 10 to 12 to the main body 21 of the support body 2.

As illustrated in FIG. 13, the main body 21 of the support body 2 includes protrusions 211. The plurality of protrusions 211 are arranged along the longitudinal direction of the support body 2. The protrusion 211 protrudes in the lateral direction of the support body 2. The shape of the protrusion 211 is a cylindrical shape in this example. However, the shape of the protrusion 211 may be other than the cylindrical shape, and a degree and an angle of protrusion of the protrusion 211 can be appropriately adjusted.

The antenna 1C illustrated in FIG. 13 is attached to the main body 21 of the support body 2. At this time, a gap 18 between the covering film 14 and another member is fitted into the protrusions 211 of the support body 2. By this fitting, the unit type antenna 1C is fixed to the support body 2. With the above configuration, the unit type antenna 1C is detachable from the main body 21 of the support body 2. Further, the unit type antenna 1C can be replaced.

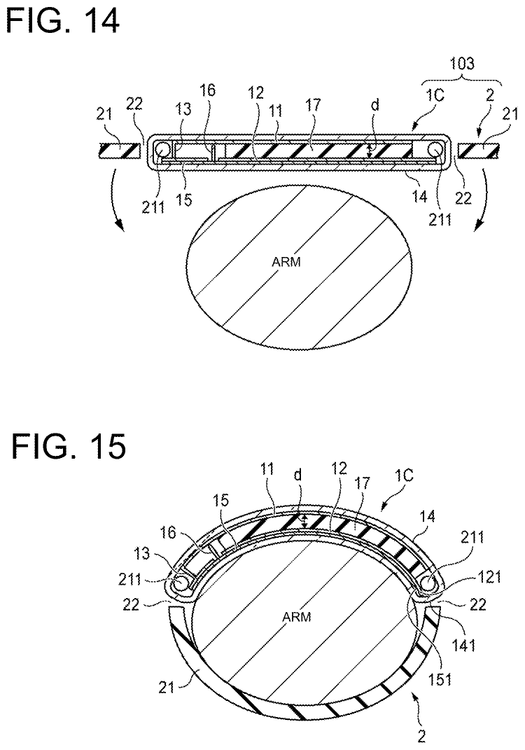

The wearable terminal 103 having the support body 2 to which the antenna 1C is attached as described above is worn on the human body. FIG. 14 is a diagram illustrating a state before the wearable terminal 103 is worn on the human body (the arm in the present example). FIG. 15 is a diagram illustrating a state after the wearable terminal 103 is worn on the human body (the arm in the present example). In this example, it is assumed that the belt-shaped support body 2 is wrapped around and worn on the arm, and an illustration of a fastener for fastening both ends of the belt-shaped support body 2 is omitted.

The support body 2 illustrated in FIG. 14 is not yet curved. By attaching the support body 2 to the arm, a state as illustrated in FIG. 15 is obtained, and the entire support body 2 is curved. The antenna 1C is also curved along the arm.

The first metal layer 11 constituting an antenna element of the antenna 1C curves following the curvature of the cushion member 17. On the other hand, since the composite of the board 15 and the second metal layer 12 constituting the ground of the antenna 1C is not bonded to the cushion member 17, the composite is curved in accordance with the shape of the arm while sliding on a surface of the cushion member 17.

Since the cushion member 17 having the predetermined thickness d is disposed, the distance between the first metal layer 11 and the second metal layer 12 is kept constant before and after the above-described curvature.

After the curvature, an arc formed by the second metal layer 12 constituting the ground has a smaller radius of curvature than an arc formed by the first metal layer 11 constituting the antenna element. Therefore, the extra length portion 121 may be generated at an end portion of the second metal layer 12 along with the curvature. However, the hole portion 22 provided in the support body 2 accommodates the extra length portion. The hole portion 22 also accommodates the extra length portion 151 of the board 15 and the extra length portion 141 of the covering film 14.

As described above, even when the wearable terminal 103 having the support body 2 to which the antenna 1C is attached is worn on the human body and is curved, the first metal layer 11 and the second metal layer 12 is not broken. Further, the distance between the first metal layer 11 and the second metal layer 12 can be kept constant. Accordingly, the terminal 103 having the two layers of the antenna element and the ground has sufficient flexibility as a whole and is wearable.

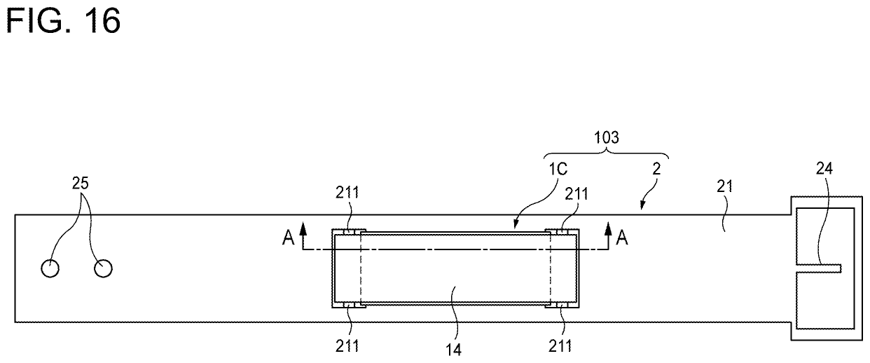

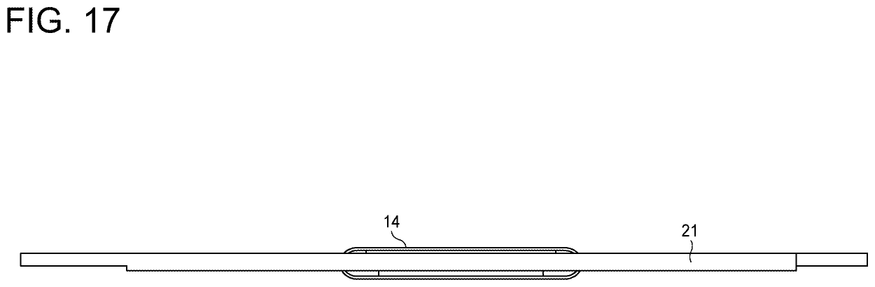

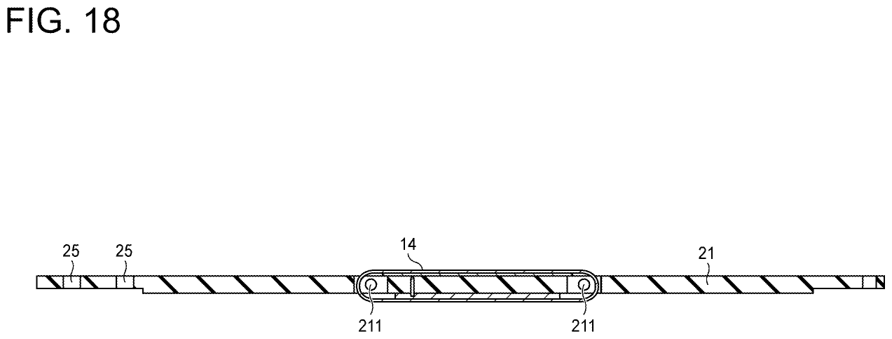

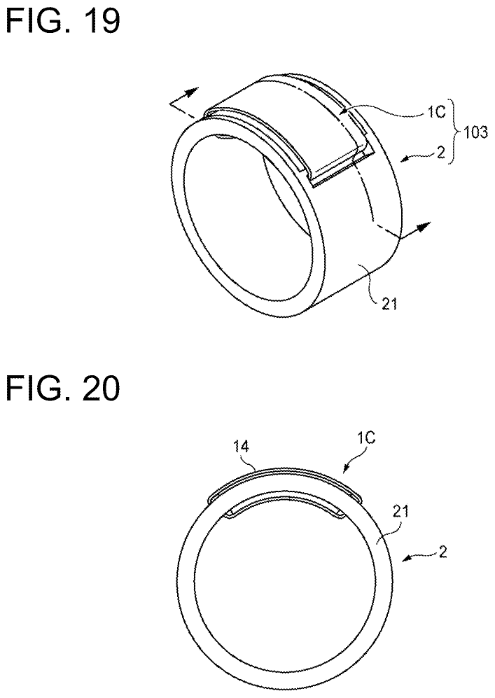

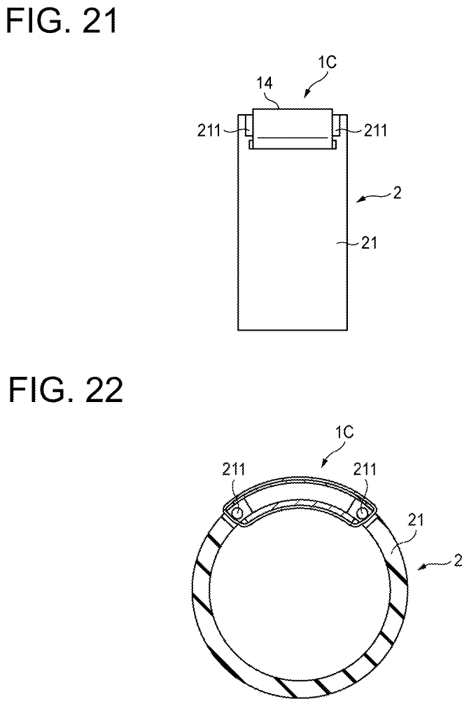

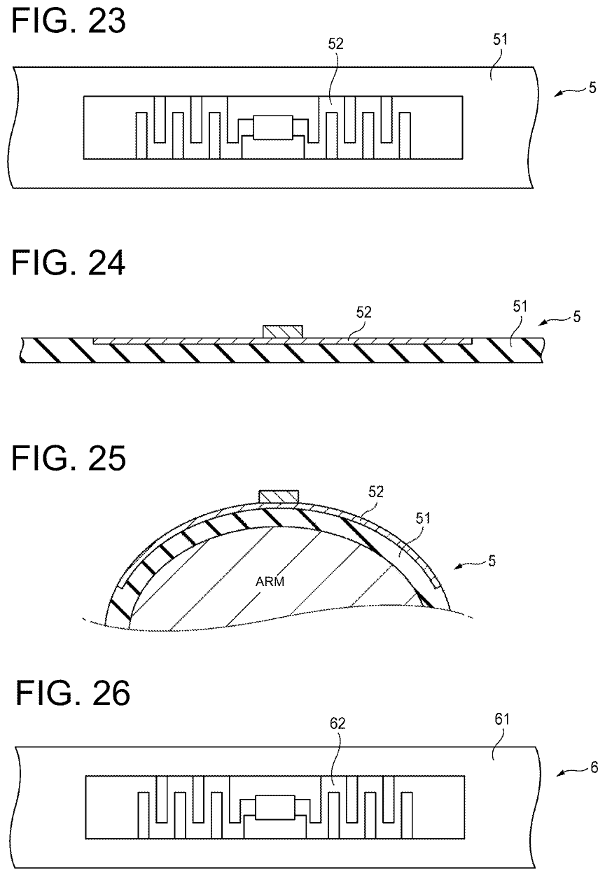

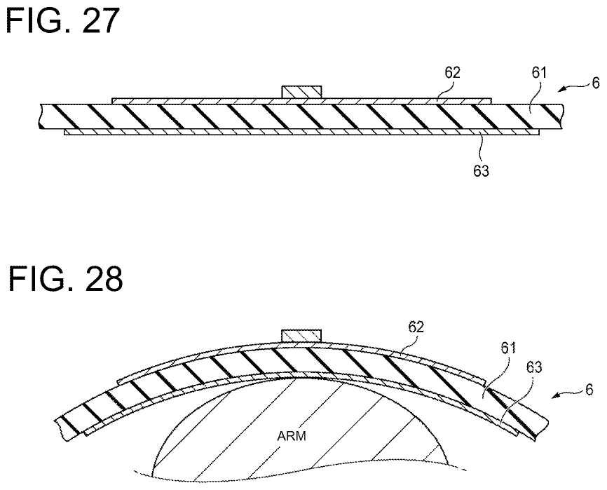

FIG. 16 is a top view illustrating a structure of the wearable terminal 103. FIG. 17 is a side view illustrating the structure of the wearable terminal 103. FIG. 18 is a cross-sectional view taken along a line A-A of FIG. 16 and illustrating the structure of the wearable terminal 103. FIG. 19 is a perspective view illustrating a state in which the wearable terminal 103 illustrated in FIGS. 16 to 18 is curved in a ring shape. FIG. 20 is a front view illustrating the state in which the wearable terminal 103 illustrated in FIGS. 16 to 18 is curved in the ring shape. FIG. 21 is a side view illustrating the state in which the wearable terminal 103 illustrated in FIGS. 16 to 18 is curved in the ring shape. FIG. 22 is a cross-sectional view taken along a chain line portion of FIG. 19 and illustrating the state in which the wearable terminal 103 illustrated in FIGS. 16 to 18 is curved in the ring shape.

As illustrated in FIGS. 16 to 18, the support body 2 is a wristband, and fasteners 24 and 25 are provided at both ends of the main body 21 in the longitudinal direction. By wrapping the support body 2 illustrated in FIGS. 16 to 18 around the arm and engaging the fasteners 24 and 25, the wearable terminal 103 can be worn on the human body (in this example, the arm).

In FIGS. 19 to 22, the fasteners 24 and 25 are not illustrated. It can be clearly seen from FIGS. 19 to 22 that the antenna 1C is attached to the main body 21 of the support body 2.

As described above, the support body may have the hole portion, and when the wearable terminal is curved, the hole portion may accommodate the extra length portion generated in the arc or more necessary for a member located further inside the curve than the cushion member. According to the above configuration, even when the wearable terminal including the antenna of the two-layer structure having the predetermined thickness is curved, the hole portion accommodates the extra length portion caused by a difference in a radius of curvature of each member. Therefore, the wearable terminal can be appropriately curved.

In the above configuration, the antenna is an inverted F-shaped antenna, the first metal layer and the second metal layer are connected to each other via the short-circuit portion, and the first metal layer and the board are connected to each other via the power supply pin. The antenna may be a patch antenna, and the first metal layer and the board may be connected to each other via the power supply pin.

In the above configuration, the antenna may include the cushion member, and the support body may include the protrusions for attaching the antenna. According to the above configuration, the antenna including the cushion member can be a unit detachable from the main body of the support body.

Although various embodiments have been described above with reference to the drawings, it is needless to say that the present disclosure is not limited thereto. It will be apparent to those skilled in the art that various changes and modifications can be conceived within the scope of the claims, and it is also understood that the various changes and modifications belong to the technical scope of the invention. Further, the respective constituent elements in the above-described embodiments may be optionally combined within a range not departing from the gist of the present disclosure.

What is claimed is:

1. A wearable terminal comprising:
a support body;
an antenna having a first metal layer and a second metal layer;
a board; and
a covering film that covers the first metal layer, the second metal layer, and the board,
wherein the first metal layer constitutes an antenna element and the second metal layer constitutes a ground;
wherein the first metal layer and the second metal layer each are made of a metal having flexibility or a metal foil formed on a material having flexibility;
wherein the first metal layer is bonded to the covering film;
wherein the support body or the antenna includes a cushion member;
wherein the cushion member is attached so that the cushion member is sandwiched between the first metal layer and the second metal layer, and the cushion member separates the first metal layer and the second metal layer by a predetermined distance;
wherein the covering film is bonded to the support body; and
wherein a composite of the second metal layer and the board is not bonded to the cushion member.

2. The wearable terminal according to claim 1,
wherein the support body has a hole portion; and
wherein the hole portion accommodates an extra length portion of a member located further inside a curve than the cushion member, the extra length portion being generated in a state that the wearable terminal is curved.

3. The wearable terminal according to claim 1,
wherein the antenna is an inverted F-shaped antenna;
wherein the first metal layer and the second metal layer are connected to each other via a short-circuit portion; and
wherein the first metal layer and the board are connected to each other via a power supply pin.

4. The wearable terminal according to claim 1,
wherein the antenna is a patch antenna; and
wherein the first metal layer and the board are connected to each other via a power supply pin.

5. The wearable terminal according to claim 3,
wherein the antenna includes the cushion member; and
wherein the support body has a protrusion configured to attach the antenna.

6. The wearable terminal according to claim 1,
wherein the composite of the second metal layer and the board is slidable with respect to the cushion member.

7. The wearable terminal according to claim 2,
wherein the member located further inside the curve than the cushion member is at least one of the second metal layer, the board, and the covering film.
